(19) United States
(12) Patent Application Publication
(10) Pub. No.: US 2025/0258326 A1
(43) Pub. Date: Aug. 14, 2025

(54) DIRECTIONAL RADIATION DEVICE AND APPLICATION

(71) Applicant: Changchun Institute Of Optics, Fine Mechanics And Physics, Chinese Academy Of Sciences, CHANGCHUN (CN)

(72) Inventors: WEI LI, CHANGCHUN (CN); FEI XIE, CHANGCHUN (CN); HAO PAN, CHANGCHUN (CN); YANG AN, CHANGCHUN (CN); LONGNAN LI, CHANGCHUN (CN); NAIQIN YI, CHANGCHUN (CN)

(21) Appl. No.: 19/176,967

(22) Filed: Apr. 11, 2025

Related U.S. Application Data
(63) Continuation-in-part of application No. PCT/CN2024/078791, filed on Feb. 27, 2024.

(30) Foreign Application Priority Data
Aug. 24, 2023 (CN) 202311070952.6
Aug. 24, 2023 (CN) 202311070953.0
Aug. 24, 2023 (CN) 202311070954.5

(51) Int. Cl. G02B 5/20

(52) U.S. Cl. CPC G02B 5/208

(57) ABSTRACT

The present disclosure discloses a directional radiation device and its use, which regulates radiation by specifying angles or angular ranges to achieve infrared broadband angular-asymmetric directional thermal radiation. Additionally, the geometric structure of the asymmetric unit can be adjusted to enhance infrared radiation at specific angles; by changing the material of the spectral selection layer, the wavelength of thermal radiation can be controlled, enabling spectrally selective emission in the infrared band. A porous film is attached to the directional radiation device to enhance its reflectivity in the solar wavelength range, thereby truly achieving passive radiative cooling on vertical and inclined surfaces.

### CROSS-REFERENCE TO RELATED APPLICATIONS

The present disclosure claims priority of Chinese Patent Application No. 202311070954.5, filed with the Chinese Patent Office on Aug. 24, 2023, and entitled “Broadband Asymmetric Angle Selective Thermal Radiation Device and Application”, the entire contents of which are herein incorporated by reference in the present disclosure.

The present disclosure claims priority of Chinese Patent Application No. 202311070952.6, filed with the Chinese Patent Office on Aug. 24, 2023, and entitled “Spectrally Selective Asymmetric Thermal Radiation Device and Its Preparation Method”, the entire contents of which are herein incorporated by reference in the present disclosure.

The present disclosure claims the priority of Chinese Patent Application No. 202311070953.0, filed with the Chinese Patent Office on Aug. 24, 2023, and entitled “Application of Directional Radiation Devices in Radiative Cooling”, the entire contents of which are herein incorporated by reference in the present disclosure.

### TECHNICAL FIELD

The present disclosure relates to the field of thermal radiation technology, in particular to a directional radiation device and its application.

### BACKGROUND

Thermal radiation is essentially broadband, incoherent, and omnidirectional, and any object with a temperature above absolute zero will emit energy outward. However, directional thermal radiation can offer significant advantages, such as improved energy transfer efficiency and minimized energy loss in undesired directions. This capability holds promising applications in fields such as stray light suppression in optical systems, radiative heat transfer, radiative propulsion, radiative heating, radiative cooling, infrared encryption, thermal control, and more.

Currently, structures such as periodic gratings, gradient ENZ materials, and multilayer films enable the manipulation of the temporal and spatial coherence of thermal radiation. However, the emissivity of these designs is symmetrically distributed in space, resulting in a lack of directionality in the radiation. Some designs achieve asymmetric thermal radiation by breaking structural symmetry, but these are typically limited by narrow bandwidths, narrow angular ranges, or polarization dependence. Although certain designs utilizing micro/nano-structures can achieve directional radiation, their small structural dimensions relative to the wavelength of the emitted radiation impose restrictions on how the radiation is emitted, leading to significant polarization dependence in these small-scale devices. To maximize energy transfer efficiency, directional thermal radiation devices need to exhibit both broadband and polarization-independent characteristics. Therefore, polarization-independent, broadband, angularly selective asymmetric thermal devices are crucial for achieving directional radiation in the infrared spectrum.

However, applications such as infrared sensing, infrared imaging, radiation temperature control, radiative heating, and radiative cooling require thermal radiation control in specific wavelength ranges and over a wide angular range. Therefore, it is also necessary to be able to simultaneously control the radiation angle and spectrum, enabling directional radiative devices to possess both angular selectivity and spectral selectivity.

### SUMMARY

One objective of the present disclosure is to provide a directional radiation device with broadband and angularly selective characteristics, addressing issues in existing emitters such as narrow bandwidth, limited angular tunability, symmetric thermal radiation, and polarization dependence; On the other hand, the present disclosure optimizes the material of the radiative surface to only emit radiation in specific spectral range, achieving directional radiation with the controllability of spectral selectivity, angular asymmetry and polarization independence; Another purpose is to provide an application of directional radiation devices for radiative cooling, which enhances infrared radiation within the atmospheric window while reducing the absorption of radiation from the ground and surrounding objects, ultimately achieving subambient radiative cooling on surfaces at specific angles, such as in a vertical or inclined plane at any angle.

To solve the above-mentioned technical problems, the present disclosure provides the following technical solutions:

A directional radiation device, comprising: a plurality of asymmetric units using infrared absorbing material as a substrate, wherein each of the plurality of asymmetric units includes a reflective surface, a radiative surface, and a bottom surface, the reflective surface is provided with a first infrared reflective layer, and a width of the bottom surface is greater than or equal to 50 μm;

The radiative surface forms an angle α with the bottom surface, and the reflective surface forms an angle β with the bottom surface, by adjusting the angle α and the angle β, a directional radiation angle is scalable, an adjustable range of the directional radiation angle is −90° to 90°; and

The angle α between the radiative surface and the bottom surface of each of the plurality of asymmetric units is 90°, while the angle β between the reflective surface and the bottom surface increases or decreases sequentially.

wherein the angle α plus the angle β is greater than or equal to 90°, and the plurality of asymmetric units have different effects on incident waves with different angles;

when an incident angle θ≤−β, the incident waves are in a reflection region, the plurality of asymmetric units reflect the incident waves;

when the incident angle −β≥θ≤90°−2β, the incident waves are in a transition region, the plurality of asymmetric units partially reflect and partially absorb the incident waves;

when the incident angle θ≥90°−2β, the incident waves are in a absorption region, the plurality of asymmetric unit absorbs the incident waves;

wherein, a normal direction of the bottom surface is 0°, a direction of the reflective surface is a negative region, and a direction of the radiative surface is a positive region.

by adjusting the angle β between the reflective surface and the bottom surface, the range of the reflection region, the transition region, and the absorption region can be changed.

In one optional embodiment, wherein the radiative surface is also provided with a spectrally selective layer, wherein the spectrally selective layer is made of a material that has an absorption effect on a specific spectral range, and the specific spectral range is the same as a spectral range of the incident wave that needs to be directionally radiated, the material of the spectrally selective layer is adjusted according to the application requirements and the intrinsic absorption of the material to achieve spectral selectivity for directional radiation.

In one optional embodiment, wherein a second infrared reflective layer is also arranged between the spectrally selective layer and the substrate.

In one optional embodiment, wherein the infrared absorbing material has an infrared emission wavelength range of 4-20 μm, an emissivity of the infrared absorbing material is greater than or equal to 0.5.

In one optional embodiment, wherein an infrared reflectivity of the first infrared reflective layer and the second infrared reflective layer is greater than 60%.

In one optional embodiment, wherein a substrate material comprises at least one of polymers and metals, and the first infrared reflective layer and the second infrared reflective layer are at least one of silver, aluminum, gold, titanium, copper, chromium, ITO (indium tin oxide), AZO (aluminum-doped zinc oxide), GZO (gallium-doped zinc oxide), FTO (fluorine-doped tin oxide), MXenes, metasurfaces, nanophotonic crystals, and multilayer films.

In one optional embodiment, wherein the reflective and/or the radiative surface is a free-form surface.

In one optional embodiment, wherein the spectral selection layer is made of a material that has an absorption effect on 8-13 μm spectral range, and the second infrared reflective layer is made of a material that has a reflective property on sunlight and infrared radiation to achieve radiative cooling.

In one optional embodiment, wherein the spectral selection layer is made of silicon nitride.

In one optional embodiment, wherein a fabrication process of the substrate of the plurality of asymmetric units includes at least one of molding, imprinting, photolithography, etching, and injection molding.

A use of a directional radiation device, wherein a layer of porous film is attached to a top of the asymmetric unit of the directional radiation device according to claim 10 to enhance solar reflectivity; a pore size of porous film is 0.2-2.5 μm, and the porous film has high reflectivity in the wavelength range of 0.25-1.5 μm and high direct transmittance in the wavelength range of 8-13 μm;

The directional radiation device attached with the porous film is tilted or vertically arranged, the radiative surface faces the sky and the reflective surface faces the ground.

In one optional embodiment, wherein the porous film is made of UHMWPE (ultra-high molecular weight polyethylene) and/or HDPE (high-density polyethylene).

Compared with existing technologies, the above technical solutions have the following advantages:

The present disclosure can achieve asymmetric distribution of emissivity in different angle ranges by adjusting the angle between the reflection surface and the bottom surface of an asymmetric unit β, as well as the angle between the radiative surface and the bottom surface α; According to actual needs, it is possible to enhance infrared radiation at a specified angle; The design of asymmetric units with increasing gradient and decreasing gradient angles enables directional radiation devices to meet the problem of different required radiation angle range in different application scenarios and regions; And the width of the asymmetric unit is set to no less than 50 μm, effectively avoiding polarization dependence issues.

The present disclosure can use a spectrally selective layer to radiate at certain spectral range, and adjust the spectral range by replacing the spectrally selective layer to meet different practical needs.

The present disclosure applies directional radiation devices in the field of radiative cooling and incorporates a porous film onto the device. The porous membrane ensures high transmittance in the infrared spectrum while effectively enhancing reflectivity in the visible spectrum. The present disclosure is the first to achieve daytime subambient radiative cooling on vertical or inclined surfaces. It can increase infrared radiation at specified angles as needed, thus enabling specific-angle infrared radiation functionality. On one hand, it achieves high solar reflectivity and enhances infrared radiation within the atmospheric window. On the other hand, it reduces absorption of radiation from the ground and surrounding objects, ensuring that the energy received from the sun and the ground is less than the energy radiated out, thus realizing passive radiative cooling functionality on vertical or inclined surfaces.

### BRIEF DESCRIPTION OF THE DRAWINGS

To elucidate the technical solutions within the present disclosure or existing technologies more clearly, a concise introduction to the accompanying drawings necessary for the embodiments or descriptions of existing technologies will be provided below. It is evident that the described drawings below represent some embodiments of the present disclosure. It should be noted that within this field, individuals possessing ordinary technical expertise may derive additional drawings based on these illustrations, without necessitating inventive effort.

FIG. 1 is a partial structural schematic diagram of a directional radiation device with broadband asymmetric angle selectivity provided by an Embodiment of the present disclosure;

FIG. 2 is a schematic diagram of a reflection region, a transition region, and an absorption region provided by Embodiment of the present disclosure;

FIG. 3 is a variation diagram of emissivity with incident angle and included angle β for directional radiation devices with the same base width according to the simulation experiment provided by Embodiment 1 of the present disclosure;

FIG. 4 is a variation diagram of emissivity with base width and included angle β under TE polarization mode provided by Embodiment 1 of the present disclosure;

FIG. 5 is a variation diagram of emissivity with base width and included angle β under TM polarization mode provided by Embodiment 1 of the present disclosure;

FIG. 6 is a hemispherical distribution map of emissivity obtained from the simulation results for radiation direction provided by Embodiment 1 of the present disclosure;

FIG. 7 is a physical illustration of a directional radiation device with broadband asymmetric angle selectivity provided by embodiment 1 of the present disclosure;

FIG. 8 is a simulation graph depicting the variation of emissivity with angle and wavelength for directional radiation device embodying broadband asymmetric angle selectivity provided by Embodiment 1 of the present disclosure. These devices operate under conditions characterized by an aspect ratio coefficient of 2:3, and width equals to 1 mm and incident wavelength ranges from 4 to 20 μm;

FIG. 9 is a schematic diagram of a directional radiation device provided by Embodiment 1 of the present disclosure, in which the angle β increases sequentially;

FIG. 10 is a partial structural schematic diagram of a directional radiation device with spectral selectivity provided by Embodiment 2 of the present disclosure;

FIG. 11 is a schematic diagram of a directional radiation device with spectral selectivity provided by Embodiment 2 of the present disclosure, in which the angle β increases sequentially;

FIG. 12 is a schematic diagram of the reflection region, transition region, and absorption region provided by Embodiment 2 of the present disclosure;

FIG. 13 is a variation diagram of emissivity with incident angle for the directional radiation device provided by Embodiment 2 of the present disclosure;

FIG. 14 is a variation diagram of emissivity with incident angle for the directional radiation device provided by Embodiment 2 of the present disclosure, wherein the spectrally selective layer material is replaced with PDMS;

FIG. 15 is a variation diagram of emissivity with bottom surface width under TE polarization mode, as provided by Embodiment 2 of the present disclosure;

FIG. 16 is a variation diagram of emissivity with bottom surface width under TM polarization mode provided by Embodiment 2 of the present disclosure;

FIG. 17 is a process flowchart for the preparation of a directional radiation device with spectral selectivity provided by Embodiment 2 of the present disclosure;

FIG. 18 is a schematic diagram depicting the application of the directional radiation device provided by Embodiment 3 of the present disclosure;

FIG. 19 is a schematic diagram illustrating the avoidance of interbuilding thermal radiation effects using the angle-selective radiation devices provided by Embodiment 2 of the present disclosure when considering two adjacent buildings;

FIG. 20 is an outdoor radiative cooling setup provided by Embodiment 3 of the present disclosure;

FIG. 21 is a comparison graph illustrating the temporal variation in temperature for the directional radiation devices, conventional radiative cooling device, commercial white paint, and the ambient environment, as well as the temperature differences between these components and the ambient temperature, as provided by Embodiment 3 of the present disclosure.

### DETAILED DESCRIPTION

In order to make the above objectives, features, and advantages of the present disclosure more obvious and understandable, a detailed explanation of the specific embodiments of the present disclosure will be provided below in conjunction with the accompanying drawings.

Specific details are elaborated in the following description to facilitate a thorough understanding of the present disclosure. However, the present disclosure can be implemented in various ways different from the other described herein, and those skilled in the art can make similar promotions without violating the connotation of the present disclosure. Therefore, the present disclosure is not limited by the specific embodiments disclosed below.

### Embodiment 1

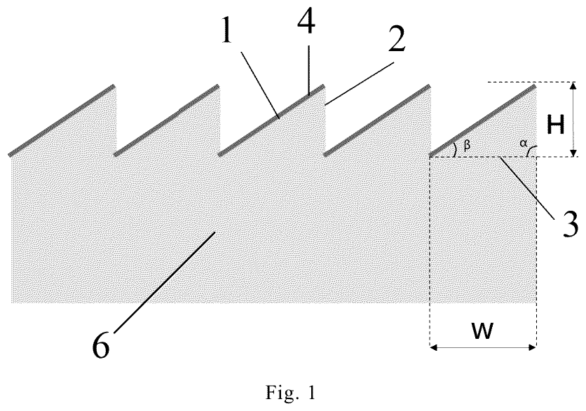

As shown in FIG. 1, a specific embodiment of the present disclosure provides a directional emitter with broadband asymmetric angularly selective characteristics, comprising a plurality of asymmetric units with infrared absorbing material serving as the substrate 6. The infrared emission of the infrared-absorbing material is in the wavelength range of 4-20 βm, with the emissivity greater than or equal to 0.5.

Each of the plurality of asymmetric units comprises a reflective surface 1, a radiative surface 2, and a bottom surface 3, which are presented as a triangle overall. Moreover, the reflective surface 1 is coated with the first infrared reflective layer 4 for which the infrared reflectance is greater than 60%.

Definition: The angle between the radiative surface 2 and the bottom surface 3 is α, the angle between the reflective surface 1 and the bottom surface 3 is, this definition also applies to Embodiments 2 and 3.

In order to achieve directional radiation and overcome polarization dependence, it is required that to the angle α of the asymmetric unit is not equal to the angle β. Preferably, a is greater than B, and the width of the bottom surface 3 is greater than or equal to 50 μm. Based on the above structure, the angle of directional radiation can be selected by varying a and B, ranging from −90° to 90°. The angle β between the reflective surface 1 and the bottom surface 3 of the plurality of asymmetric units shows a sequentially increasing or decreasing variation to adapt to different requirements for radiation angles in different regions. When all regions require the same radiation angle, the plurality of asymmetric units can also use the same angle β.

As a preferred embodiment, the angle α between the radiative surface 2 and the bottom surface 3 of the plurality of asymmetric units are all 90°, and the angle β between reflective surface 1 and the bottom surface 3 are the same for all units, satisfying 0.1≤tan β≤10. At this point, the asymmetric units are present as a right-angled triangle, with H represents the height of the asymmetric unit, i.e., is the length of radiative surface 2; W represents the width of asymmetric unit, i.e. the length of bottom surface 3; R represents the ratio of the height H to the width W of the asymmetric unit.

The substrate material of the substrate 6 adopts polymer or metal, or a combination of polymer and metal. In this embodiment, resin, specifically PDMS solution is used. The preparation process of the substrate 6 can utilize at least one of the following methods: reverse molding, embossing, lithography, engraving, and injection molding. In this embodiment, prepared by injection molding. PDMS is poured into a mold with closed surroundings and a periodic right-angled triangle inverse structure enclosed around it. Heating and molding are conducted at 75° C., followed by cooling and curing, then demolding to obtain substrate 6 with a periodic right-angled triangle structure. A silver film of 50 nm-500 nm is formed by magnetron sputtering, thermal evaporation, or electron beam on the inclined surface (i.e. the reflective surface) of substrate 6 as the first infrared reflective layer 4. To ensure the quality of the silver film and its adhesion to PDMS substrate 6, a 2-10 nm chromium film is pre-formed as the adhesion layer, and the thickness of the silver file is determined to be 100 nm-200 nm, considering various factors after tests.

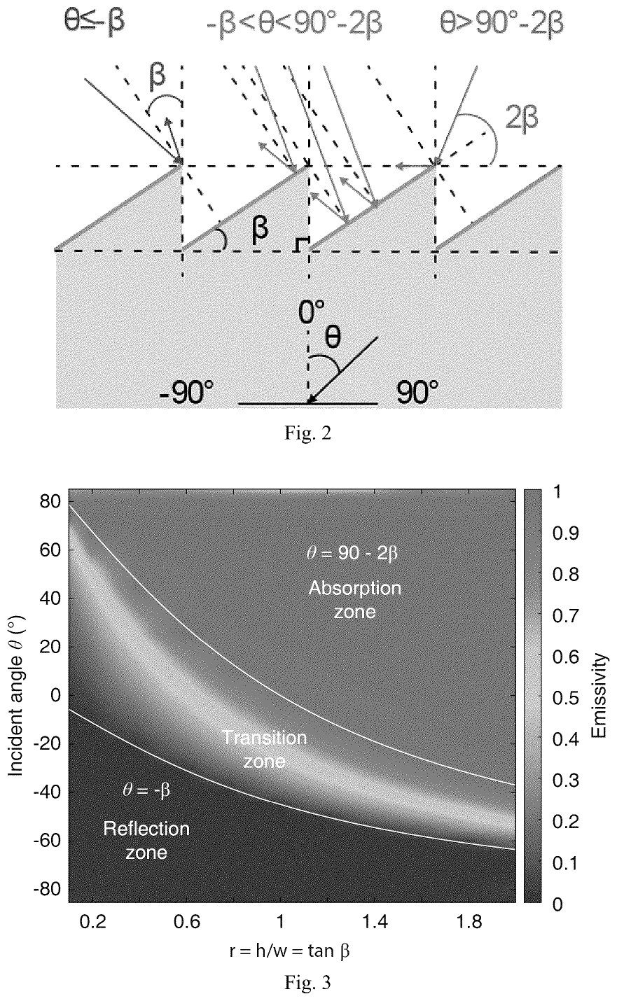

As depicted in FIG. 2, taking the asymmetric unit of a right-angled triangle as an example, elucidate the varied effects that the asymmetric unit has on incident waves with different angles of incidence.

Firstly, define the normal direction of the bottom surface 3 as 0°, with the negative region toward the reflective surface 1, and the positive region toward the radiative surface 2. The incident angle of the incident wave is θ.

When the incident angle θ of the incident wave is less than or equal to −β, the incident wave resides in the reflective region. The asymmetric unit acts to reflect the incident wave, and based on the law of reflection, all incident waves will be reflected outward.

When the incident angle of the incident wave lies within the range of −β≤θ≤90°−2β,the incident wave is situated in the transition region. In this region, the asymmetric unit exhibits partially reflection and partially absorption effects on the incident wave. Part of the incident wave will be reflected out by upper region of reflective surface 1. Another portion of the incident wave will be reflected by the lower region of reflective surface 1 to radiative surface 2. Subsequently, this portion of the incident wave will be absorbed by the radiative surface 2.

When the incident angle of the incident wave is greater than or equal to 90°−2β, the incident wave is situated with in the absorption region, in this region, the asymmetric unit acts to absorb the incident wave, a portion of the incident wave is directly absorbed by radiative surface 2, while another portion is reflected by upon reflective surface 1 to the radiative surface 2 and absorbed by the radiative surface 2.

Based on the analysis of the above principles, it can be concluded that by adjusting the angle β between the reflective surface 1 and the bottom surface 3 (i.e. the aspect ratio of the asymmetric unit), the range of the reflection region, transition region, and absorption region can be altered. To verify the above effects, the plurality of sets of simulation experiments were conducted, and the following 8 sets of simulation experiment data were provided as proof.

Experiment 1: The width of the bottom surface 3 is 1 mm, and the aspect ratio is 0.2.

Experiment 2: The width of the bottom surface 3 is 1 mm, and the aspect ratio is 0.4.

Experiment 3: The width of the bottom surface 3 is 1 mm, and the aspect ratio is 0.6.

Experiment 4: The width of the bottom surface 3 is 1 mm, and the aspect ratio is 0.8.

Experiment 5: The width of the bottom surface 3 is 1 mm, and the aspect ratio is 1.0.

Experiment 6: The width of the bottom surface 3 is 1 mm, and the aspect ratio is 1.2.

Experiment 7: The width of the bottom surface 3 is 1 mm, and the aspect ratio is 1.4.

Experiment 8: The width of the bottom surface 3 is 1 mm, and the aspect ratio is 1.6.

As shown in FIG. 3, when the aspect ratio of asymmetric units change, the emissivity varies with the angle θ, In the aforementioned 8 experiments, the wavelength of the incident wave was consistently 8 μm. It can be observed that as the aspect ratio of the asymmetric unit changes from Experiment 1 to Experiment 8, the emissivity also changes with the angle. When the aspect ratio of the asymmetric unit is 1.6 (Experiment 8), there is a significant increase in emissivity starting from −60°. At −30°, the emissivity approaches 1, maintaining high emissivity thereafter. Conversely, with the aspect ratio of the asymmetric unit is 0.2 (Experiment 1), it can be seen that the emissivity of the device is greatly suppressed, only beginning to rise close to 0° and reaching 1 by 60°. Between 60° and 90°, the emissivity remains at 1. Therefore, it can be seen that adjusting the aspect ratio of the asymmetric unit can effectively modulate the device's emissivity characteristics across different angles. The aspect ratio of asymmetric units can be adjusted by changing the height H while fixing width W, or by changing width W while fixing the height H, or both dimensions can be adjusted simultaneously.

Additionally, the embodiment of the present disclosure addresses the polarization dependence issue present in the prior art by investigating the width of the bottom surface 3. By fixing aspect ratio of the asymmetric unit while simultaneously adjusting the height H and width W, a plurality of simulation experiments were conducted, providing insights into the impact of structural dimensions on asymmetric radiation under different polarization modes.

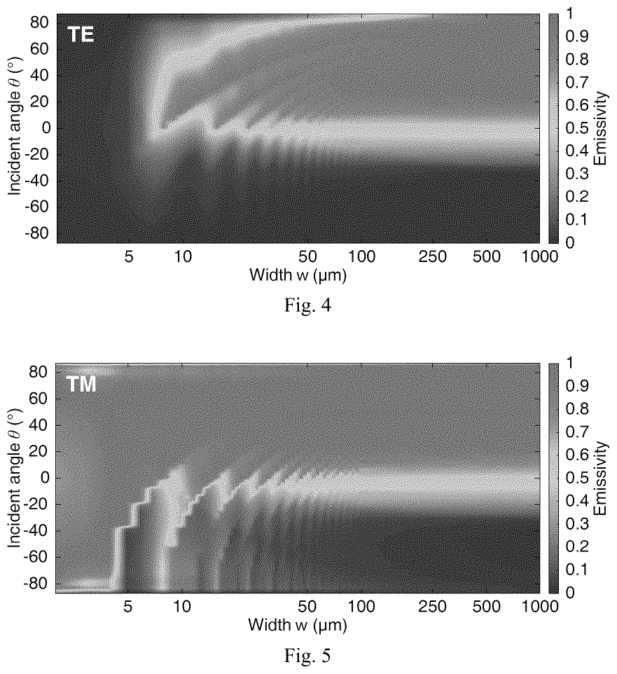

As shown in FIGS. 4 and 5, the wavelength of the incident wave is both 8 μm. When the aspect ratio of a fixed asymmetric unit is 2:3, as the width gradually increases from 2 μm to 1000 μm, the angular distribution of the emissivity changes accordingly. When the width is less than 5 μm, the emissivity is close to θ in TE polarization mode, while TM polarization is in a higher emissivity state, at this point, the angular distribution of emissivity remains symmetric. When the width gradually increases from 5 μm to 50 μm, an asymmetric emissivity distribution gradually emerges in both polarization modes. In TE polarization mode, there are more emissivity peaks, and the peak value of the emissivity also increase. This indicates that an increase in width enhances the emissivity for a specific wavelength range of infrared radiation. This demonstrates that the infrared radiation characteristics are related to the size of the asymmetric unit. When the width W exceeds 50 μm, the infrared radiation performance is stable, and the emissivity distribution of the two polarization modes becomes essentially consistent, overcoming polarization dependence.

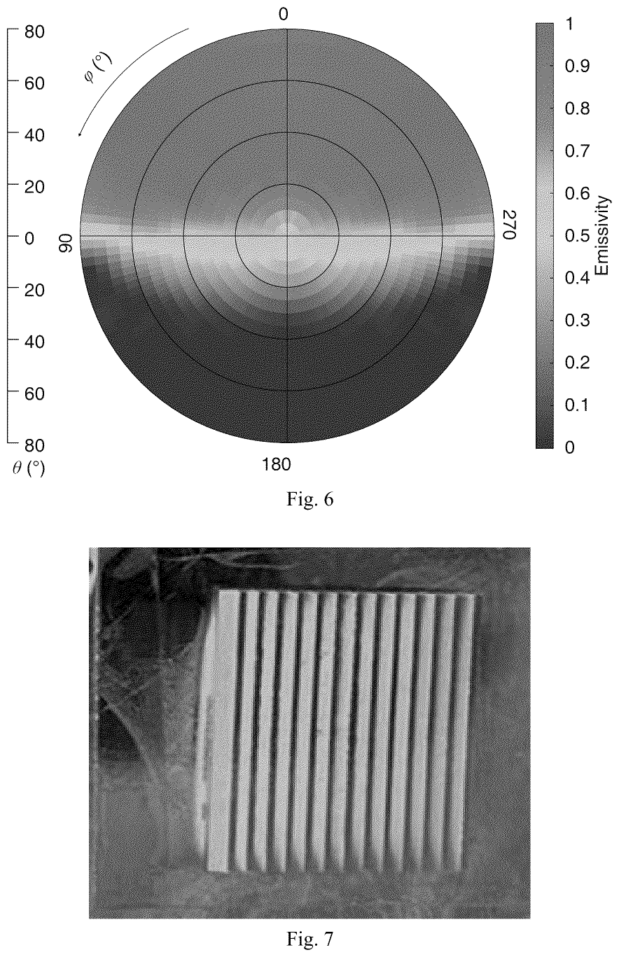

To verify the directional radiation performance of a device with broadband angular selectivity, a simulation experiment was conducted under the condition of an aspect ratio of 2:3, and the width W=1 mm, and the incident wave with a wavelength λ=8 μm. As shown in FIG. 6, it can be observed that within the hemispherical radiation region of the device, half of the area exhibits high emissivity, corresponding to high radiation, while the other half shows low emissivity, corresponding to high reflection. This demonstrates the realization of broadband asymmetric directional thermal radiation.

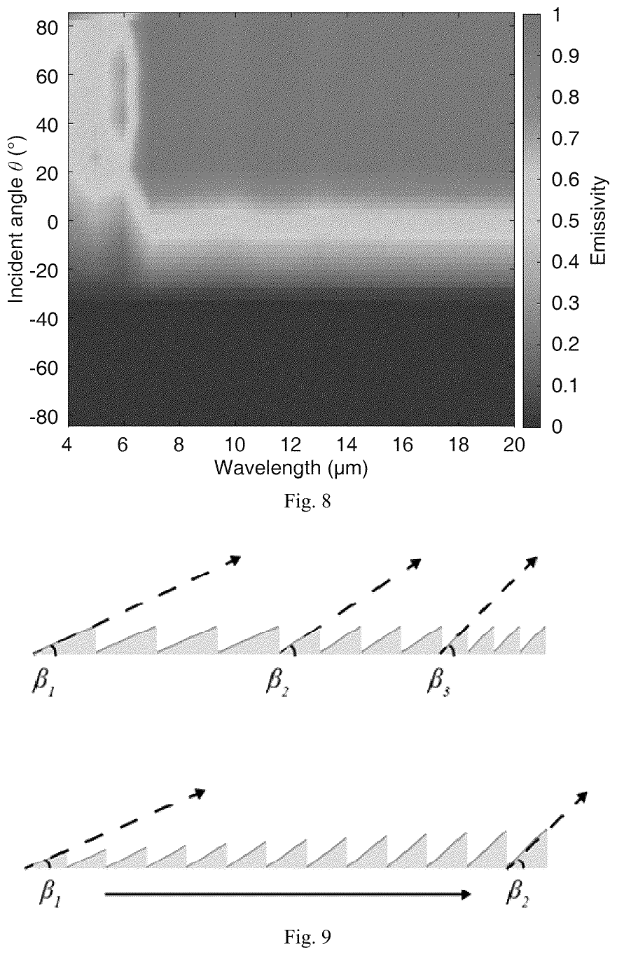

As shown in FIG. 7, based on the above-mentioned content, a directional radiation device with broadband angularly-asymmetric characteristics was fabricated. For incident waves at different angles, the device exhibits different reflection characteristics. Through simulation calculations, it can be found that the emissivity of the device changes with angle and wavelength as shown in FIG. 8.

In addition, the reflective surface 1 and/or the radiative surface 2 can also be a free-form surface, for example, when the reflective surface 1 is a convex or concave curved surface, the angle β should be the slope of the tangent to the curved surface at the point where the incident wave intersects with the reflective surface 1. In this case, directional radiation can also be achieved, but the radiation range and angle will change, and the basic principle remains unchanged. When the radiative surface 2 is a concave surface, the situation is basically the same as for a flat surface. When the radiative surface 2 is a convex surface, a part of the light that would originally be radiated in the transition region in the flat surface state, but in the curved state, that part would be blocked and absorbed by radiative surface 2, its basic principle remains unchanged.

As shown in FIG. 9, the asymmetric unit of the directional radiation device adopts a design with a gradient of the angle β to meet the requirement for different radiation angle ranges in different regions. The value of β for each asymmetric unit, or for each group of units, is different, allowing for the realization of spatial angular distribution of varying high and low radiation performance for each or each group of asymmetric units.

In practical production applications, directional radiation devices are commonly used in fields such as radiative cooling, radiative heating, or radiative propulsion, and they show promising application prospects. Specifically, by adjusting the radiation angle range of directional radiation device, cooling effects can be achieved on inclined or vertical surfaces of specific objects or areas. This technology can be applied in scenarios such as building exterior walls and automobiles with cooling requirements; Alternatively, by controlling the radiation angle range of directional radiation device, heat can be accurately transferred to the target objects that needs to be heated, enabling rapid and efficient heating process. This technology can be applied in industries, healthcare, laboratories, aerospace, and other fields; Implementing directional radiation devices as radiation sources to generate high-efficiency radiation, propulsion effects can be achieved. This technology can be applied in spacecraft propulsion systems such as solar sails and photon propulsion systems.

### Embodiment 2

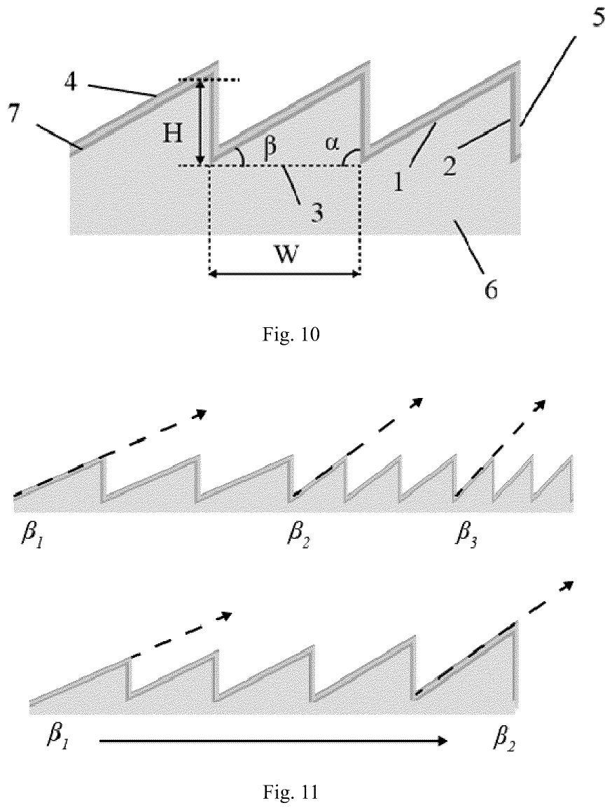

As shown in FIG. 10, a specific embodiment of the present disclosure provides a directional radiation device with spectrally selective characteristics, comprising the plurality of asymmetric units, the asymmetric units are composed of a substrate 6 and a coating on its surface. The material of the substrate 6 can be resin or any other material, preferably a polymer material suitable for demolding to facilitate the preparation of the substrate 6 by molding. The substrate 6 has a triangular shape, and includes a reflective surface 1, a radiative surface 2, and a bottom surface 3. The second infrared reflective layer 7 is fully coated on the surface of substrate 6, followed by a fully covered spectral selection layer 5 on the second infrared reflective layer 7. Finally, only a first infrared reflective layer 4 is coated on the reflective surface of the fully covered spectrally selective layer 5. The infrared reflectance of the first infrared reflective layer 4 and the fully covered second infrared reflective layer 7 is greater than 90%. High reflectivity metals such as silver and aluminum can be selected. Testing has determined that a silver film with a thickness of 100 nm-400 nm on the surface of the substrate 6 provides the best results. To ensure the quality of the silver film and its adhesion to the PDMS substrate, a chromium film with a thickness of 2-10 nm can be pre-formed as the adhesive layer. The spectrally selective layer 5 absorbs radiation only in specific wavelength range that require directional radiation. Therefore, the material of spectrally selective layer 5 can be adjusted according to the application requirements and the intrinsic absorption properties of the material to achieve spectral selectivity in directional radiation. The emissivity of spectrally selective layer 5 should not be less than 0.2. Replacing the material of the spectrally selective layer 5 according to actual needs is an important innovative aspect of the present disclosure.

In response to different infrared spectral requirements, the spectrally selective layer 5 can be made of polymers or multilayer films with finite thickness and spectral selectivity. For different visible and infrared spectral requirements, the reflective surface 1 can choose materials with high absorption in the visible spectrum and high reflectivity in the infrared spectrum, or high transmittance in the visible spectrum and high reflectivity in the infrared spectrum. The radiative surface 2 can be made from materials with high absorption in the visible spectrum and broadband or spectrally selective properties in the infrared spectrum, or materials with high transmittance in visible spectrum and broadband or spectrally selective properties in the infrared spectrum. In Embodiment 2, the focus is on the spectral selective emission within the atmospheric window. A silicon nitride film with a thickness of 4 μm is selected. When the spectrally selective layer 5 is made of silicon nitride film, a second infrared reflective layer 7 is also provided on the bottom surface of the spectrally selective layer 5. Silicon nitride exhibits distinct emission peaks or emission bands within the infrared spectrum. The silicon nitride has relatively low absorption and high transparency in the visible spectrum range, as a result, the silicon nitride cannot effectively reflect the visible light. An additional layer of silver film is placed below the silicon nitride film to reflect the incident wave in the visible spectrum.

To achieve directional radiation and overcome polarization dependence, it is required that the asymmetric units satisfy α>β, and the width of the bottom surface 3 is greater than or equal to 50 μm. Based on the above-mentioned structure, it is possible to modify directional radiation angle by α and β, with the radiation angle ranging from −90° to 90°.

As shown in FIG. 11, as a preferred embodiment, the angle α between the radiative surface 2 and the bottom surface 3 of each asymmetric unit is 90°, the angle β between the reflective surface 1 and the bottom surface 3 increasing or decreasing sequentially.

As a preferred embodiment, the angle α between the radiative surface 2 and the bottom surface 3 of each asymmetric unit is 90°. A specified number of asymmetric units are divided into a group, with the angle β of the asymmetric unit within each set being the same, the angle β of asymmetric units in different set increases or decrease sequentially.

As a preferred embodiment, the infrared absorbing material on the radiative surface 2 is a polymer, multilayer film, carbon nanotubes, or ceramic.

As a preferred embodiment, both the first infrared reflective layer 4 and the second infrared reflective layer 7 are selected from at least one of the following materials: silver, aluminum, gold, titanium, copper, chromium, ITO (indium tin oxide), AZO (aluminum-doped zinc oxide), GZO (gallium-doped zinc oxide), FTO (fluorine-doped tin oxide), MXenes, metasurfaces, nanophotonic crystals, and multilayer films.

As a preferred embodiment, the angle α between the radiative surface 2 and the bottom surface 3 of each asymmetric unit α are all 90°, the angle β between the reflective surface 1 and the bottom surface 3 is the same for all units, satisfying 0.1≤tan β≤10. At this point, the asymmetric unit takes the shape of a right-angled triangle, and H represents the height of the asymmetric unit, which is the length of radiative surface 2; W represents the width of asymmetric unit, which is the length of bottom surface 3; r represents the ratio of the height H to the width W of the asymmetric unit.

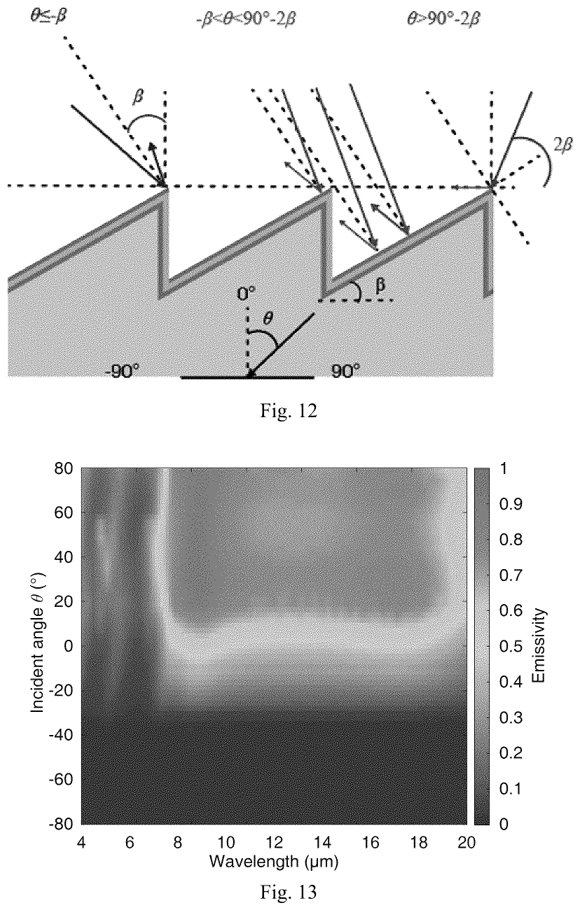

As shown in FIG. 12, taking the right-angled triangular asymmetric unit as an example, the different effects of the asymmetric unit on incident waves with various incident angles are illustrated:

First, define the normal direction of the bottom surface 3 as 0°, with the region closer to the reflective surface 1 as the negative region, and the region closer to the radiative surface 2 as a positive region. The incident angle of the incoming wave is θ.

When the incident angle θ≤−β, the incident wave is within the reflection region, the asymmetric unit reflects the incident wave. Based on the reflection law, all incident waves will be reflected away.

When the incident angle of the incident wave lies within the range of −β≤θ≤90°−2β, the incident wave is situated in the transition region. In this region, the asymmetric unit exhibits partially reflection and partially absorption effects on the incident wave. Part of the incident wave will be reflected out by upper region of reflective surface 1. Another portion of the incident wave will be reflected by the lower region of reflective surface 1 to the radiative surface 2. Subsequently, this portion of the incident wave will be absorbed by the radiative surface 2.

When the incident angle θ≥90°−2β, the incident wave is in the absorption region, the asymmetric unit fully absorbs the incident wave. A portion of the incident wave is directly absorbed by the radiative surface 2, while another portion is reflected by upon reflective surface 1 to the radiative surface 2 and absorbed by the radiative surface 2.

Based on the above principle, it can be concluded that by adjusting the angle β between the reflective surface 1 and the bottom surface 3 (i.e. the aspect ratio of asymmetric units), the range of the reflection region, transition region, and absorption region can be altered.

As shown in FIG. 13, the simulated emissivity of spectrally selective asymmetric thermal emitter for incident waves at different angles is presented. Due to the intrinsic properties of silicon nitride, significant absorption peaks occur only within the atmospheric window, resulting in a high emissivity only in the wavelength range of 8-16 μm. It can be observed that the spectrum shows three regions corresponding to changes in the incident angle, the reflection region, transition region, and absorption region, these regions correspond to the low emissivity region at the bottom, the moderate emissivity region in the middle, and the high emissivity region at the top of the spectrum.

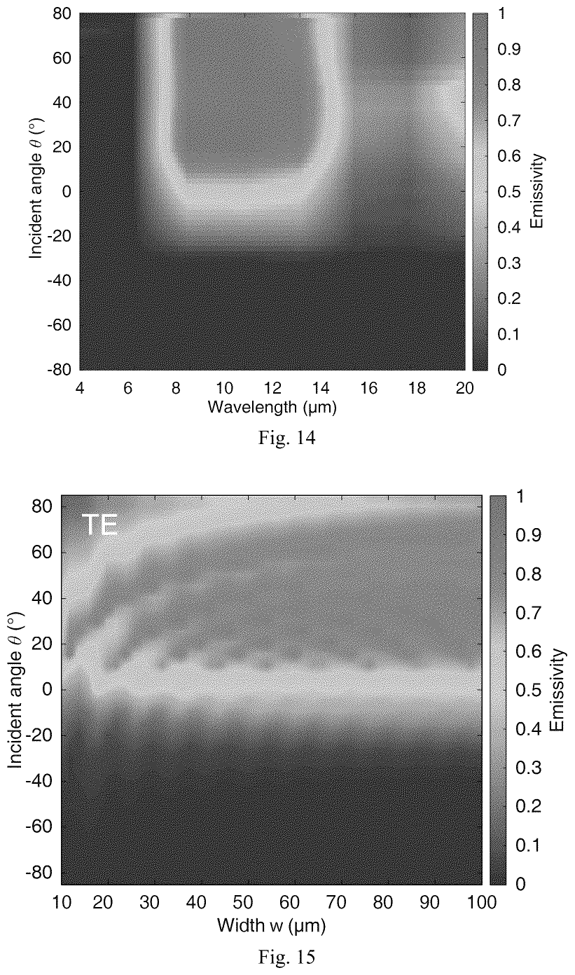

As shown in FIG. 14, replacing the silicon nitride material with a PDMS (polydimethylsiloxane) material of 4 μm thickness enables spectrally selective asymmetric thermal radiation in the wavelength range of 8-14 μm.

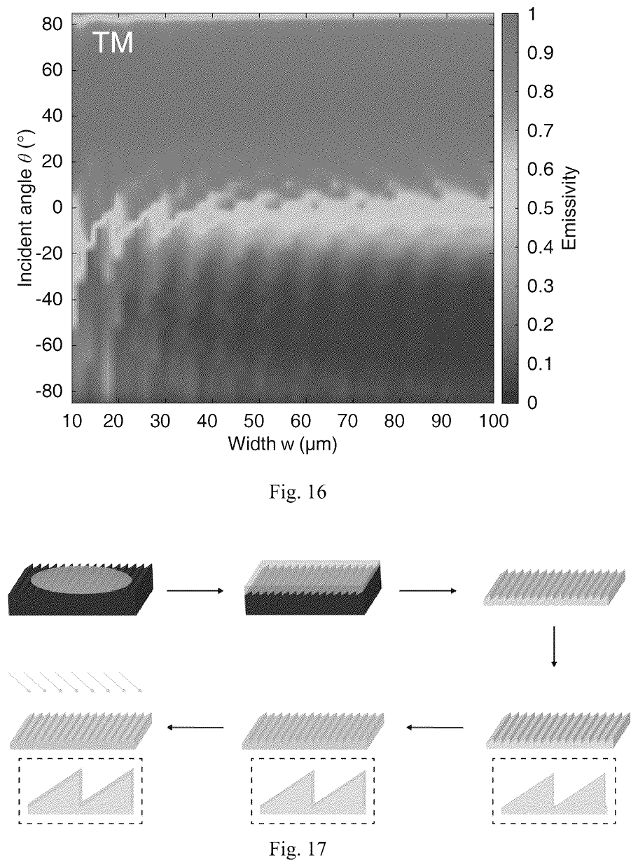

As shown in FIGS. 15 and 16, when the aspect ratio of the asymmetric unit is 2:3, as the width gradually increases from 2 μm to 100 μm, the angular distribution and magnitude of emissivity change accordingly, when the width gradually increases to 50 μm, more emissivity peaks appear under TE and TM polarization modes, and the peak value of the emissivity also rise. This indicates that increasing the width enhances the infrared emission capability of the asymmetric unit for specific wavelength ranges. This demonstrates that the infrared radiation characteristics are related to the size of the asymmetric unit. When the width W exceeds 50 μm, the infrared radiation performance becomes stable, and the emissivity distribution of the two polarization modes become nearly identical, thereby overcoming polarization dependence. Therefore, the width of the bottom surface 3 should be above 50 μm, in contrast existing technologies primarily focus on nanoscale structures, which are constrained by the polarization state of the incident waves. This distinction forms the fundamental difference between the present disclosure and prior studies. In addition, the reflective surface 1 and/or the radiative surface 2 can also be a free-form surfaces.

As shown in FIG. 17, a fabrication method is provided for spectrally selective directional radiation device described in embodiment 2. This methods involves injecting a PDMS solution into a mold with closed boundaries and a periodic inverse right angled triangle structure, the mold is heated at 75° C.-80° C. to solidify the structure, and after cooling and curing, the structure is demolded to obtain a structure with the plurality of asymmetric units. On the structure, a 100-500 nm silver film is deposited via magnetron sputtering or thermal evaporation to achieve full coverage. Then, a 4 μm silicon nitride film is grown on the surface of the silver film. Subsequently, a silver film with a thickness of 100 nm-400 nm is selectively formed on the silicon nitride film of reflective surface 1 by adjusting the angle between the sample and the electron beam deposition direction, thereby completing the preparation of a spectrally selective asymmetric thermal radiation device. Compared to the traditional method of directly depositing films on both surfaces, this layer by layer deposition process simplifies the process and improves the quality at the intersection of the two surfaces, resulting in a lower defect rate.

### Embodiment 3

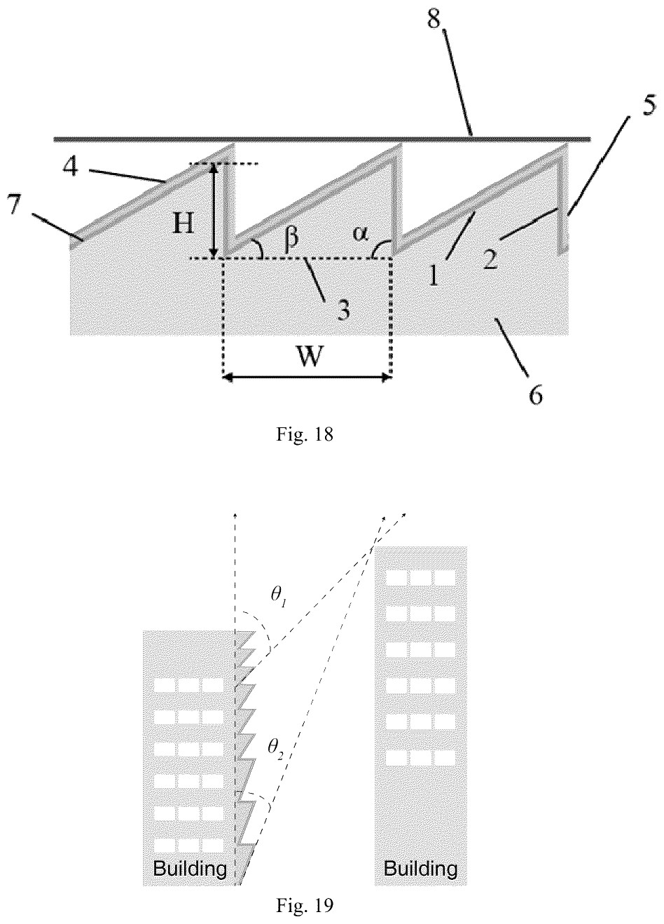

As shown in FIG. 18, the present disclosure provides an application of the directional radiation device in radiative cooling, with a structure based on the spectrally selective directional radiation device described in embodiment 2. The specific application scenarios are vertical or inclined surfaces. In existing technologies, radiative cooling functionality is primarily achieved using nanophotonic crystal structures, porous materials, or polymer coatings. Although these materials perform well on horizontal surfaces, their cooling efficiency is significantly reduced or even lost on vertical or inclined surfaces due to the substantial thermal radiation emitted by the ground. For example, in the case of vertical surfaces during a hot summer, the ground can heat up to approximately 50-60° C. from absorbing solar radiation, leading to considerable thermal gain for building facades. When conventional radiative cooling materials are applied to building surfaces, they primarily mitigate the impact of solar radiation but cannot address the thermal radiation from the ground. The combined radiative energy from the sun and the ground exceeds the energy radiated away by these materials. Consequently, conventional radiative cooling materials lack passive cooling characteristics and fail to achieve true cooling functionality.

In this embodiment, the spectral selection layer 5 on the radiative surface 2 of the directional radiation device consists of a 4 μm thickness silicon nitride film. Although silicon nitride produces significant emission peaks or bands in the infrared spectrum range, it has relatively low absorption of visible light and high transparency in visible light. Consequently silicon nitride cannot effectively reflect sunlight. Therefore, a silver film (the second infrared reflective layer 7) is placed between the spectral selection layer 5 and the substrate 6 to reflect sunlight. The first infrared reflective layer 4 on reflective surface 1 reflects the radiation from the ground and the environmental radiation, preventing energy absorption. Due to the intrinsic absorption of the metal layer in the ultraviolet wavelength range, the first infrared reflective layer 4 will absorb a large part of the energy of sunlight, resulting in a deterioration or even failure of the cooling effect. Therefore, a porous polyethylene film 8 is applied to the top of the asymmetric units, specifically made of ultra-high molecular weight polyethylene (UHMWPE) and/or high-density polyethylene (HDPE). The pore size of the porous film 8 is matched to the wavelength of solar spectrum, ranging from 0.2-2.5 μm, with its porosity and thickness designed as needed. The porous film 8 has high reflectivity in the visible light range of 0.25-1.5 μm and high direct transmittance in the atmospheric transparent window range of 8-13 μm. After combining porous film 8 with directional radiation devices, it enhances the reflectivity of solar spectrum while maintaining the device's directional radiation in the infrared range, greatly enhancing the radiative cooling effect.

In this embodiment, the primary goal of the present disclosure is to achieve cooling function by overcoming the radiation energy from solar radiation, ground radiation and environmental radiation. The directional radiation device emits the infrared radiation into the sky while reflecting the solar radiation, the ground radiation and environmental radiation to prevent energy absorption. As shown in FIG. 19, the directional radiation device is inclined or vertically positioned, with the radiative surface 2 facing the sky and the reflective surface 1 facing the ground. When the present disclosure is applied to radiative cooling on the exterior walls of buildings, it is necessary to design gradient β asymmetric units to meet the different radiation angle range requirements of different areas of the building according to the surrounding building obstruction situation.

Compared to existing technologies, the present disclosure not only addresses solar radiation but also resolves the issue caused by ground and environmental radiation, and further improves the reflection effect on the sunlight through a porous film. The energy sum of solar radiation, ground and environmental radiation on directional radiation devices incident on the directional radiation device, minus the energy emitted directionally by the radiative surface 2 and the energy reflected by the reflective surface 1, resulting in a negative value. This truly achieves passive cooling. In contrast, existing technologies fail to address ground and environmental radiation, yielding a positive value instead. As a result, they cannot achieve true cooling. In addition, existing radiative coolers lack angular selectivity and cannot achieve directional radiation, as a result, they are limited to horizontally installations and are not suitable for inclined or vertical surfaces. In the present disclosure, the embodiment of the directional radiation device of the present embodiment can achieve angular selectivity by adjusting the angle between the reflective surface 1 and the bottom surface 3, enabling directional radiation even on inclined or vertical surfaces.

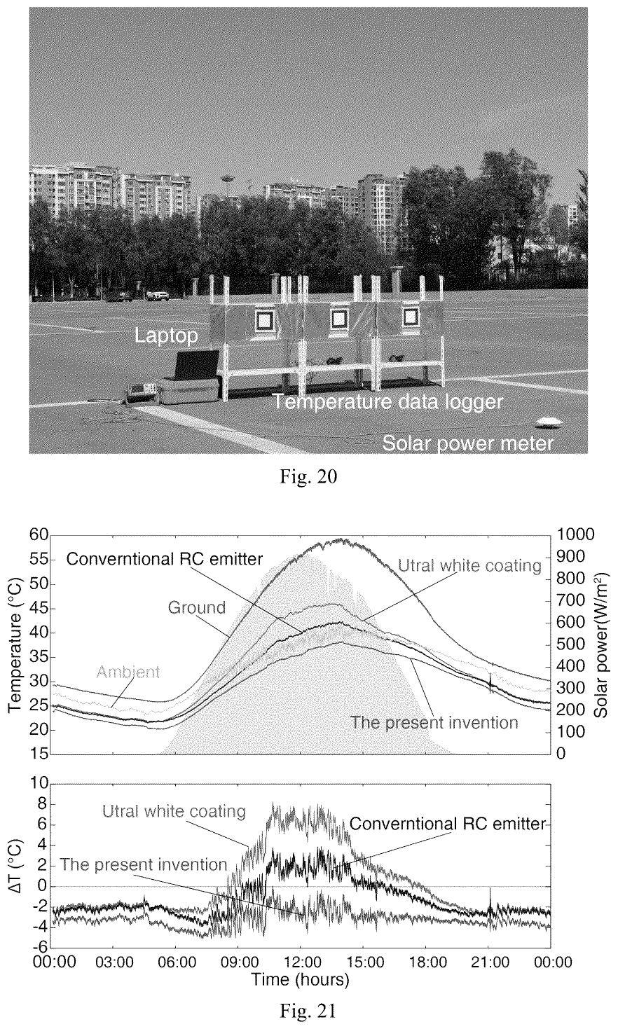

As shown in FIGS. 20 and 21, outdoor tests were conducted to verify the effectiveness of the directional radiation devices (with the porous film attached) in achieving radiative cooling on vertical surfaces. The directional radiation device was compared with commercial white paint and conventional radiative cooling device in terms of cooling performance. The temperature differences between these materials and the ambient temperature over time were plotted. In the experiment, the asymmetric unit of directional radiation device had a height of 0.66 mm and a width of 1 mm, the device exhibited high emissivity within an 8-13 μm atmospheric window, and demonstrated spectral selectivity with asymmetric directional thermal radiation. Half of the device's hemispherical radiation region featured high emissivity, while the other half exhibited low emissivity. From the figures, the conclusion can be drawn that compared to commercial white paint and conventional radiative cooling device, the embodiment of the present disclosure can achieve cooling effect when the directional emitter device was placed vertically, its temperature was approximately 2.5° C. lower than the ambient temperature, achieving the true passive cooling. However, commercial white paint and conventional radiative cooling devices showed temperature approximately 6.4° C. and 1.8° C. higher than the ambient temperature, respectively, failing to achieved effective cooling effects.

It should also be noted that the relational terms such as first and second are only used to distinguish one entity or operation from another entity or operation, and do not necessarily require or imply any actual relationship or order between these entities or operations. Moreover, the terms “including”, “comprising”, or any other variation are intended to encompass non-exclusive inclusion, such that a process, method, item, or device that includes a series of elements not only includes those elements, but also includes other elements that are not explicitly listed, or also includes elements inherent to such process, method, item, or device. Without further limitations, the elements limited by the statement “including one . . . ” do not exclude the existence of other identical elements in the process, method, item, or device that includes the other common elements.

In this specification, the various embodiments are described in a progressive manner, and each embodiment highlighting its differences from other embodiments, for parts that are identical or similar reference may be made to the descriptions to other embodiments.

The above description of the disclosed embodiments enables professionals in the art to implement or use the present disclosure. The various modifications to these embodiments will be apparent to professionals in the art, and the general principles defined herein may be implemented in other embodiments without departing from the spirit or scope of the present disclosure. Therefore, the present disclosure is not to be limited to the embodiments shown herein, but is to be accorded the broadest scope consistent with the principles and novel features disclosed herein.

### DESCRIPTIONS OF REFERENCE NUMERALS

1 reflective surface, 2 radiative surface, 3 bottom surface, 4 first infrared reflective layer, 5 spectrally selective layer, 6 substrate, 7 second infrared reflective layer, and 8 porous film.

What claimed is:

1. A directional radiation device, comprising: a plurality of asymmetric units using infrared absorbing material as a substrate, wherein each of the plurality of asymmetric units includes a reflective surface, a radiative surface, and a bottom surface, the reflective surface is provided with a first infrared reflective layer, and a width of the bottom surface is greater than or equal to 50 μm;
the radiative surface forms an angle α with the bottom surface, and the reflective surface forms an angle β with the bottom surface, by adjusting the angle α and the angle β, a directional radiation angle is scalable, an adjustable range of the directional radiation angle is −90° to 90°; and
the angle α between the radiative surface and the bottom surface of each of the plurality of asymmetric units is 90°, while the angle β between the reflective surface and the bottom surface increases or decreases sequentially.

2. The directional radiation device according to claim 1, wherein the angle α plus the angle β is greater than or equal to 90°, and the plurality of asymmetric units have different effects on incident waves with different angles;
when an incident angle θ≤−β, the incident waves are in a reflection region, the plurality of asymmetric units reflect the incident waves;
when the incident angle −β≤θ≤90°−2β, the incident waves are in a transition region, the plurality of asymmetric units partially reflect and partially absorb the incident waves;
when the incident angle θ≥90°−2β, the incident waves are in a absorption region, the plurality of asymmetric units absorb the incident waves;
wherein, a normal direction of the bottom surface is 0°, a direction of the reflective surface is a negative region, and a direction of the radiative surface is a positive region;
by adjusting the angle β between the reflective surface and the bottom surface, the range of the reflection region, the transition region, and the absorption region are changed.

3. The directional radiation device according to claim 1, wherein the radiative surface is also provided with a spectrally selective layer, wherein the spectrally selective layer is made of a material that has an absorption effect on a specific spectral range, and the specific spectral range is the same as a spectral range of the incident wave that needs to be directionally radiated, the material of the spectrally selective layer is adjusted according to the application requirements and the intrinsic absorption of the material to achieve spectral selectivity for directional radiation.

4. The directional radiation device according to claim 3, wherein a second infrared reflective layer is also arranged between the spectral selection layer and the substrate.

5. The directional radiation device according to claim 1, wherein the infrared absorbing material has an infrared emission wavelength range of 4-20 μm, an emissivity of the infrared absorbing material is greater than or equal to 0.5.

6. The directional radiation device according to claim 4, wherein an infrared reflectivity of the first infrared reflective layer and the second infrared reflective layer is greater than 60%.

7. The directional radiation device according claim 1, wherein a substrate material comprises at least one of polymers and metals, and the first infrared reflective layer and the second infrared reflective layer are at least one of silver, aluminum, gold, titanium, copper, chromium, ITO (indium tin oxide), AZO (aluminum-doped zinc oxide), GZO (gallium-doped zinc oxide), FTO (fluorine-doped tin oxide), MXenes, metasurfaces, nanophotonic crystals, and multilayer films.

8. The directional radiation device according to claim 1, wherein the reflective and/or the radiative surface is a free-form surface.

9. The directional radiation device according to claim 4, wherein the spectral selection layer is made of a material that has an absorption effect on 8-13 μm spectral range, and the second infrared reflective layer is made of a material that has a reflective property on sunlight and infrared radiation to achieve radiative cooling.

10. The directional radiation device according to claim 9, wherein the spectrally selective layer is made of silicon nitride.

11. The directional radiation device according to claim 9, wherein a fabrication process of the substrate of the plurality of asymmetric units includes at least one of molding, imprinting, photolithography, etching, and injection molding.

12. A use of a directional radiation device, wherein a layer of porous film is attached to a top of the asymmetric unit of the directional radiation device according to claim 10 to enhance solar reflectivity; a pore size of porous film is 0.2-2.5 μm, and the porous film has high reflectivity in the wavelength range of 0.25-1.5 μm and high direct transmittance in the wavelength range of 8-13 μm;
the directional radiation device attached with the porous film is tilted or vertically arranged, the radiative surface faces the sky and the reflective surface faces the ground.

13. The use of the directional radiation device according to claim 12, wherein the porous film is made of UHMWPE (ultra-high molecular weight polyethylene) and/or HDPE (high-density polyethylene).

14. A directional radiation device with a spectral and angular selectivity, comprising: a plurality of asymmetric units, each of the plurality of asymmetric unit includes a reflective surface, a radiative surface, and a bottom surface; a first infrared reflective layer is arranged on the reflective surface, and a spectrally selective layer is arranged on the radiative surface; the spectrally selective layer is made of a material that has an absorption effect on a specific spectral range, and a second infrared reflective layer is arranged on a bottom surface of the spectrally selective layer; the specific spectral range is a range that requires directional radiation; a width of the bottom surface is equal to or greater than 50 μm; the radiative surface forms an angle α with the bottom surface, the reflective surface forms an angle β with the bottom surface, and the angle α plus the angle β is greater than or equal to 90°; by adjusting the angle α and the angle β, a directional radiation angle is scalable, an adjustable range of the directional radiation angle is −90° to 90°.

15. The directional radiation device with the spectral and angular selectivity according to claim 14, wherein the spectrally selective layer uses silicon nitride.

16. A use of a directional radiation device in radiative cooling, comprising: a plurality of asymmetric units and a porous film; each of the plurality of asymmetric units includes a reflective surface, a radiative surface, and a bottom surface; s first infrared reflective layer is arranged on the reflective surface, and a spectrally selective layer is arranged on the radiative surface; the spectrally selective layer is made of a material that has an absorption effect on 8-13 μm spectral range, and a second infrared reflective layer is arranged on a bottom surface of the spectrally selective layer; a width of the bottom surface is equal to or greater than 50 μm;
the radiative surface forms an angle α with the bottom surface, the reflective surface forms an angle β with the bottom surface, and the angle α plus the angle β is greater than or equal to 90°; by adjusting the angle α and the angle β, a directional radiation angle is scalable, an adjustable range of the directional radiation angle is −90° to 90°; the porous film is arranged on a top of the plurality of asymmetric units, and has high reflectance in the wavelength range of 0.25-1.5 μm while maintaining high direct transmittance within the atmospheric transparency window of 8-13 μm; and
the directional radiation device is inclined or vertically arranged, the radiative surface faces the sky and the reflective surface faces the ground.
